(19) United States
(12) Patent Application Publication
(10) Pub. No.: US 2003/0182286 A1
(43) Pub. Date: Sep. 25, 2003

(54) System and method to save, secure and access records of discussion

(76) Inventors: Paul James Seccuro, Cocoa, FL (US); Kathleen Mary Egan, Cape Canaveral, FL (US); Sherry Reed, Cocoa, FL (US)

Correspondence Address: HARNESS, DICKEY & PIERCE, P.L.C., P.O. BOX 828, BLOOMFIELD HILLS, MI, 48303, US

(21) Appl. No.: 10/101,906

(22) Filed: Mar. 19, 2002

(51) Int. Cl. G06F 17/30

(52) U.S. Cl. 707/9

(57) ABSTRACT

A computer system records, secures and retrieves a plurality of record of discussions (RODs). RODs are generally customer contacts or meeting minutes. A system database stores the plurality of RODs. Each ROD includes an information set to distinguish each ROD. Each information set comprises data blocks stored in data tables. The data blocks are each transferred for storage in a data table using web pages. At least one of the web pages includes a field to assign a ROD security designator. Each user is also assigned a security designator or is specifically designated by an access list to view a ROD. The web pages thereafter allow a user either having the appropriate security designator or who is named to a ROD's access list to search and view selected RODs. The computer system is connectable via a scalable Internet-based environment with users in multiple organizations.

### FIELD OF THE INVENTION

The present invention relates to systems and methods to save and access records of discussions, and more particularly to systems and methods for loading records of discussions into a database, providing a security system for accessing the records of discussions and providing access to one or more selected users to retrieve each record of discussion.

### BACKGROUND OF THE INVENTION

Many databases and software applications today provide the ability to collect, sort and search data for a user's benefit. Security systems are also available which permit or deny a user access to information provided in a particular database. A need exists, however, for a system which collects and provides access security for records of discussions (RODs). A ROD is generated as a result of meetings, telephone conversations, and discussions between parties, particularly between companies and their customers.

Currently, the results of customer meetings or conversations are incorporated in exemplary forms such as memorandums, letters or electronic mail (e-mail). Individuals may collect and sort a file history of these memorandums or e-mail, however, a system is not currently available which provides a plurality of users access to this information. Conventional e-mail and memorandum systems do not provide to a plurality of users the ability to input or track action items assigned after each meeting. Conventional systems do not provide a user with the ability to input or paste an electronic mail copy, a memorandum copy, or minutes of a meeting into a general use data file which also assigns each ROD with both a status and an action field. Conventional systems also do not provide a level of security for a system collecting this data to exclude access to persons both inside or outside of an organization who should not have access to the data, and to control access within an organization such that a selection of personnel have access to each document incorporated in the system.

It is desirable to provide a ROD system to accomplish the above with the capability of ease of data input, such as on-screen computer menus, drop down lists of values, and standardized fields of data entry. It is further desirable to provide a ROD system in a format which provides access over an Internet-based network such that not only an individual company, but subsidiary companies and other selected organizations can access the database from locations remote from the initiator's location.

### SUMMARY OF THE INVENTION

The above and other objectives are provided by the systems and methods for recording, securing, and retrieving for use record of discussions (RODs) of the present invention. The systems and methods of the present invention apply Internet or web-based language and protocols and implement screens and drop-down lists of values for a ROD initiator to input and search ROD data from a unified database. From this database, additional users can access ROD information from a single ROD or from a group of RODs to exploit the data provided.

The systems and methods of the present invention further provide ROD access security which is distinguishable on several levels. Initially, each user of the system must have a log-on identification (I.D.) in order to enter the system prior to doing any data input, search or recovery of information from the system. The System Administrator referred to herein may comprise a single party having authority to initialize user access into the ROD system, and perform general administrative functions for the ROD system such as system maintenance. The System Administrator can also designate one or more Application Owners who have access to each ROD similar to the ROD initiator to add ROD data or ROD items, and add, modify or delete designated users. An initiator of a ROD initially inputs the data into the database and assigns a ROD security level varying between a value of one through five. Only subsequent users having a security level equal to or greater than the assigned ROD security level can search and view the ROD. Only the initiator of a ROD has authority to update action item status. The Application Owner and Data Custodian have the authority to assign a security level to a user. The Application Owner has the sole authority to assign a security level to a Data Custodian.

As an alternative to the preceding security level, each ROD can be designated for access by a particular person or group of persons named by the ROD initiator. Designating a party or parties for access overrides the normal security level, and the named individual(s) will be the only person(s) authorized to access and view the ROD. Similar to the limited ability of parties permitted by their security level to view a ROD, granting individual access to a ROD provides the user with only the limited authority to view the ROD contents.

In one aspect of the present invention a method for recording, securing and retrieving for use ROD items is provided. The method comprises the steps of developing a computer system including a database and interface architecture; capturing a plurality of RODs for entry in the system database; entering each ROD via a plurality of web pages of the interface architecture in the database; and interconnecting the system via a scalable Internet-based environment to a plurality of user sites.

The initiator of each ROD can electronically capture data from an electronic mail (e-mail), an electronic database copy of a letter or memorandum, or a telephone conversation or meeting minutes that has been prepared by word processing. The initiator can also directly input data forming the ROD using a ROD system web page. The initiator designates the initial security level for subsequent viewers of the ROD or has the option of identifying specific persons who can view the ROD or retrieve the data from the ROD. The system locks each ROD after data entry is complete, excluding documentation of “action items” for the ROD. Thereafter, only the initiator of the ROD has access to modify the ROD's action items' status. This ensures integrity of the data.

The ROD system of the present invention includes the capability to add, modify or display a customer. Customer information is initially input by the ROD initiator and includes sufficient information to individually distinguish both the customer and selected individual(s) within the customer organization. Individual web pages providing customer data can be searched or an individual customer can be searched using the ROD database.

One or more Data Custodians are assigned for a ROD system. Data Custodians are authorized to assign a security level to a standard user or to create new users. Data Custodians also perform ROD system data modification via selected web pages identified as look-up tables, and display, add or modify user tables. These tables are only accessible to Application Owners or Data Custodians, and can be updated only by Application Owners or Data Custodians, but not standard users of the system.

Each ROD initiator or user logs into the ROD system using a pre-assigned user I.D. After logging on, the user can search for a ROD using a set of search tools or by individually identifying a known ROD. The system permits a user to perform a “free text” search for an unknown ROD using data known to the user. Exemplary searches include a specific date or a range of dates during which the ROD was entered, the subject matter that a ROD involves, or a client or customer name, or a ROD initiator. The user can do a “free text” search and identify one or more RODs which fit the description provided in the search. The search can subsequently be narrowed or tailored to provide the limited RODs the user believes contain the information sought. If the user has been assigned a security level coincident with or higher than the security level pre-assigned to the ROD, or if the user is a designated party of the individual ROD, the user has access to open and display the contents of the ROD found by the search. If the user does not have the necessary security level to view a ROD, or if the user is not a designated party named for access to a ROD, the search will not identify those specific RODs.

In another preferred embodiment of the present invention, a data recording, securing and retrieving system is provided for using ROD items. The data system comprises a plurality of RODs each having individual data blocks to distinguish each ROD, and each capable of being electronically stored. A database electronically stores the plurality of RODs. A plurality of web pages each having a plurality of data fields are used to input each data block of each ROD into the database. Each ROD further includes a security designator to secure each ROD. The designator is attached to each ROD via at least one of the plurality of data fields of the plurality of web pages. The database is interconnected via a scalable Internet-based environment with a plurality of users.

In still another alternative embodiment of the present invention, a system architecture is provided. The system architecture comprises a plurality of RODs. The plurality of RODs are electronically stored in a database. Each ROD is transferable to the database by a plurality of web pages. The plurality of web pages are displayable on a computer display monitor of a computer workstation. Each web page displayable on the computer display monitor is linked to a security system to control access to individual RODs in the database. The database controlled by the security system is in communication with a web server. The web server is interconnected to the Internet to remotely link the database with a plurality of users.

The methods and systems of the present invention permit a user group, i.e., a company, to establish a security level coincident with the management levels of the company. The ROD system security levels range from an exemplary lowest level of 1 to an exemplary highest level of 5. In an exemplary application, the highest level is assigned to the corporate directors and officers of the company. The next and each succeeding level of security is assigned based on management levels such as vice president, manager, or supervisor. The lowest level of security provides general access to any employee of the company. Used in this manner, the security level provided by the invention grants or denies ROD access to pre-selected groups of personnel. The system can similarly be tailored to provide access to any sets of individuals that are required to see each ROD. The number of security levels can also be increased or decreased within the scope of the present invention.

A plurality of menus is provided with the ROD system of the present invention permitting an initiator or user to enter the system and access one or more RODs. It is an important feature of the present invention that the ROD system can operate with all major browsers on all major computer platforms. This ensures that access to ROD information can be transferred over the Internet (via the World Wide Web) to remote sites needing the information. Standard user interface language is incorporated in the system of the present invention. In an exemplary application, the user interface language includes hypertext markup language (HTML) and Microsoft® ACTIVE SERVER PAGES (ASP®). The ROD system provides standard embedded languages. Exemplary embedded languages are JAVASCRIPT® and VBSCRIPT®. JAVASCRIPT® applies to the user (client) for input validations and VBSCRIPT® applies to the web server. The data is preferably stored in a SQL SERVER® database. In the exemplary application, ASP® uses active data objects (ADO) to access the database and is used for all database transactions.

The systems and methods of the present invention perform the following processes:

1. Log-in,

2. Add a ROD,

3. Search for a ROD,

4. Add, modify or display an action,

5. Add, modify or display a customer,

6. Add, modify or display an access list, and

7. Data custodian functions.

A variety of data fields and command buttons are available to the user or initiator to input, update, search or recover information from the ROD system.

The ROD architecture works off commonly available user workstations, a web server, a database server, ADO to access the database, image files, and web pages. The ROD system of the present invention is intended to operate in all major browsers and on all known major computer platforms.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of the steps performed for initiating a ROD in accordance with a preferred embodiment of the present invention;

FIG. 2 is a block diagram of a ROD system in accordance with a preferred embodiment of the present invention showing the parallel paths within the ROD system available to individual users based on user status as either a ROD initiator or a non-initiator;

FIG. 3 is a block diagram of the interconnected ROD system architecture of the present invention;

FIG. 4 is a “Log-in” screen displayed for each user to enter the ROD system;

FIG. 5 is a “Default” web page displayed after each user enters the ROD system;

FIG. 6 is the “Add a ROD” web page displayed when a user selects the “Add a ROD” button of FIG. 5;

FIG. 7 is the “Display a ROD” web page displayed when a user selects the “Display a ROD” button of FIG. 5;

FIG. 8 is the “ROD Details” web page displayed after a user searches for one or more RODS;

FIG. 9 is the “Individual ROD Details” web page displayed when a user selects one of the “magnifying glass” icon buttons in the “Details” column of FIG. 8;

FIG. 10 is the “Access List Search Results” web page displayed when a user conducts a search after selecting the “Access List” button of FIG. 5;

FIG. 11 is the “Modify Access List” web page displayed when a user selects one of the “paper/pencil” icon buttons in the “Add/Update Access List” column of FIG. 10;

FIG. 12 is the “Add Action Search Results” web page displayed when a user conducts a search after selecting the “Add an Action” button of FIG. 5;

FIG. 13 is the “Add an Action” web page displayed when a user selects one of the “pencil” icon buttons in the “Add Action” column of FIG. 12;

FIG. 14 is the “Search Actions Results” web page displayed when a user conducts a search after selecting the “Display/Update Actions” button of FIG. 5;

FIG. 15 is the “ROD Actions” web page displayed when a user selects one of the “clipboard” icon buttons in the “Display Actions” column of FIG. 14;

FIG. 16 is the “Modify an Action” web page displayed when a user selects one of the “Edit” buttons in the “Edit” column of FIG. 15;

FIG. 17 is the “Add a Customer” web page displayed to allow further detail entry when a user selects the “Add Customer” button of the “Add a ROD” web page of FIG. 6;

FIG. 18 is the “Modified Add a Customer” web page displayed to allow further detail entry when a user selects the “Add a Customer” button of FIG. 5;

FIG. 19 is the “Display Customers” web page displayed when a user selects the “Display/Update Customers” button of FIG. 5;

FIG. 20 is the “Customer Details” web page displayed when a user selects one of the “magnifying glass” icon buttons in the “Details” column of FIG. 19;

FIG. 21 is the “Modify a Customer” web page displayed when a user selects one of the “Edit” buttons in the “Edit” column of FIG. 19;

FIG. 22 is the “Display Lookup” web page displayed when a user selects the “Method” button of FIG. 5;

FIG. 23 is the “Add Lookup Table Data” web page displayed when a user selects the “Add” button from the “Display Lookup” web page of FIG. 22;

FIG. 24 is the “Display Users” web page displayed when a user selects the “User” button of FIG. 5;

FIG. 25 is the “Add Users” web page displayed when the user selects the “Add” button of FIG. 24;

FIG. 26 is block diagram flow chart of the as-built design of the SQL SERVER® database of the present invention; and

FIG. 27 is a block diagram flow chart of the table data of the present invention interfaces with the main ROD processes.

### DETAILED DESCRIPTION OF THE PREFERRED EMBODIMENTS

The following description of the preferred embodiment(s) is merely exemplary in nature and is in no way intended to limit the invention, its application, or uses.

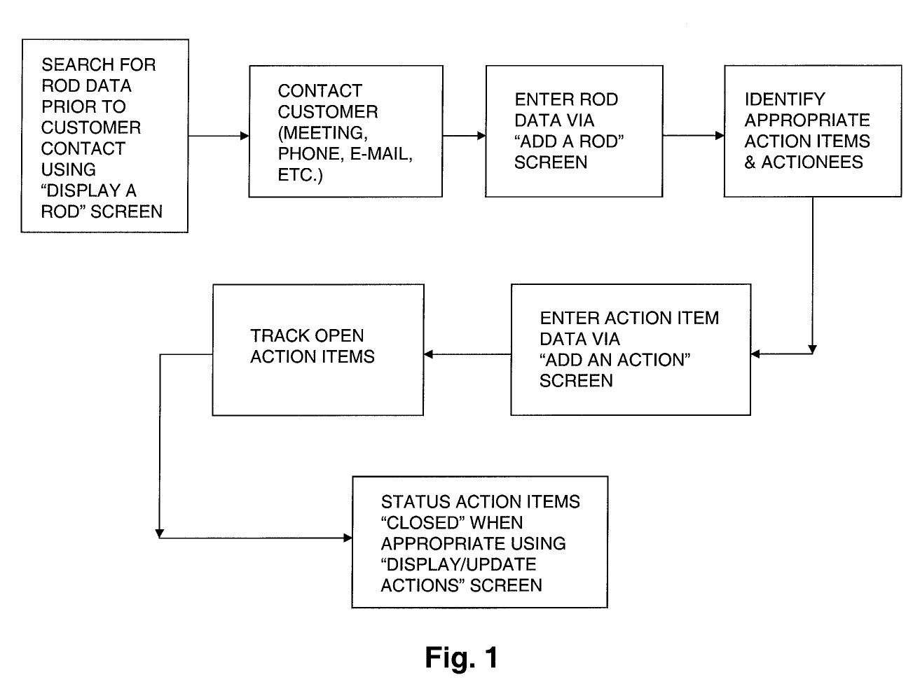

Referring to FIG. 1, a block diagram identifying a record of discussion (ROD) initiator's input to a ROD system 10, in accordance with a preferred embodiment of the present invention is shown. Initially, it is desirable to search a ROD database associated with the ROD system 10 to identify if a ROD associated with the customer is available prior to contacting the customer. This enables the user to identify, prior to contacting the customer, whether a previous ROD provided an action item, or if client or customer information in the file should be read prior to contacting the client at this time. Upon entering necessary log-on I.D. information and entering the ROD system 10, a user can search for ROD data using the “Display a ROD” web page. The user searches using the available information at the user's disposal whether a ROD is available for the particular client or customer, and also if there are action items requiring follow-up actions before contacting the client again.

After verifying if a previous ROD is available, the user contacts the customer in the normal fashion, i.e., by meeting, telephone call, electronic mail, etc. Information obtained from the customer contact is entered as a new ROD. This information adds to the ROD database and provides, if necessary, new client or customer information to the ROD database.

After the user enters the ROD information via the “Add a ROD” web page, the user must identify if appropriate action items exist and the person or persons assigned as the actionees for the action items. This action item data is entered via the “Add an Action” web page.

The ROD system 10 then permits the initiator of the ROD, and any user with access to the ROD, access to information and the action items resulting from the customer contact. The ROD initiator tracks action item status. The initiator of the ROD has access to identify the status of the action item as closed when appropriate by using the “Display/Update Actions” web page.

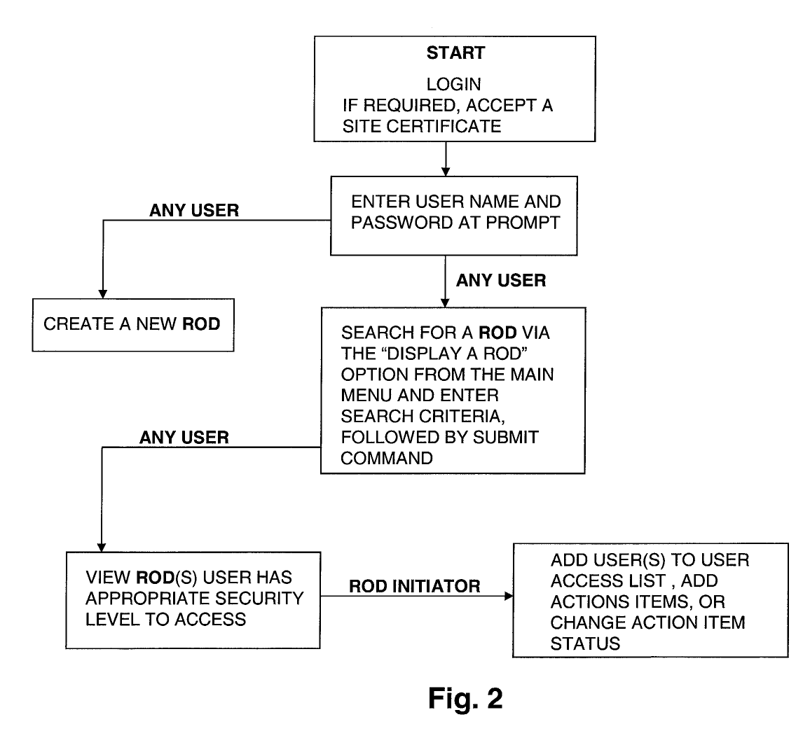

Referring to FIG. 2, a block diagram of the steps for receiving and processing ROD information by the ROD system 10 is shown. This diagram also illustrates at which steps a user of the ROD system can access information. The ROD user (who in this instance may or may not be the ROD initiator) has several options available to identify ROD information in the database. Initially, the ROD user is required to log into the ROD system 10 and, if necessary, accept a site certificate. The site certificate identifies to the user that information is transmitted in encrypted format and requires the user to accept or deny the certificate. The user must accept the site certificate to be allowed access to the ROD system 10. A System Administrator determines the duration of each site certificate. Following this, the user enters their user name and password at a screen prompt. Following entrance of the password, a main menu is provided to select options of the ROD system. As shown on FIG. 2, any user can conduct a search for a ROD via the “Display a ROD” option from the main menu and enter the search criteria followed by a submit command, or create a new ROD.

After conducting a search, a ROD user has access to ROD data via two paths. In a first path, a non-initiator of a ROD is allowed to view RODs that the user has either the appropriate security level to access or that he or she has been individually authorized to access. In a second path, a ROD initiator is permitted additional options not permitted to a non-initiator. The ROD initiator has the authority to add additional user names to the ROD access list, add action items, and change an action items' status.

In one preferred implementation, the ROD system 10 is set up using HTML and MICROSOFT® ACTIVE SERVER PAGES® (ASP®). These two languages form the primary programming languages for the ROD application. HTML is a markup language that instructs the client on how the information should be presented on a web page. ASP® is a MICROSOFT® specific scripting language that allows several different languages to be used as embedded segments to send or receive data either to or from a web page. During development, all ROD web pages are published through INTERNET INFORMATION SERVER (IIS)™ using file transfer protocol (FTP) accounts via MICROSOFT INTERDEV®. In the demonstration and production environments, software is not published but rather copied to the appropriate host server. This is because INTERDEV® does not support publishing to a site that uses secure socket layers (SSL) through MICROSOFT FRONT PAGE® server extensions when the server is running 128 bit encryption.

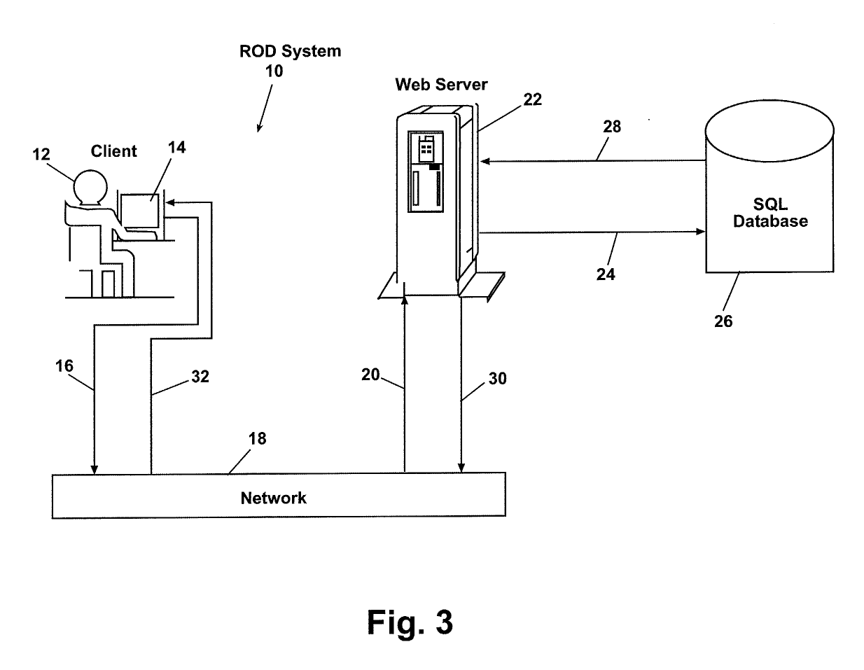

Referring now to FIG. 3, the physical architecture of the ROD system 10 is shown. FIG. 3 shows ROD system 10 having a user 12 accessing a workstation 14 wherein user 12 submits a request using a universal resource locator (URL). This request is submitted via output line 16 to a network 18. From the network 18, a network output line 20 passes the request to a web server 22. The web server 22 captures the request and locates and executes a web page. During execution of the web page, database code is generated and executed via a database request line 24 using ADO and the database 26 is accessed. The selected record is added to the database 26 if in “add” mode, or retrieved from the database 26 if in “query” mode and results returned to the web server 22 via the database output line 28. After the code has completed running, all ASP® code is stripped out leaving only HTML code. The HTML code is sent back from the web server 22 across a network return line 30 to the network 18 and from the network 18 via a network return line 32 to the workstation 14. The HTML web page is sent to the browser where the user 12 can view the HTML page.

ROD data is stored in the ROD database. In this exemplary application, data input into the ROD system 10 is stored in a SQL SERVER® version 7.0 database. In this exemplary application, ASP® is used for database transactions. The database is accessed through a single SQL SERVER® account. This account name is the same in all environments and is included in the connection string defined in a “global.asa” file. Within the database, the ROD SQL SERVER® account is assigned to both a ROD user role and a public role. The public role contains all general permissions and the ROD user role contains all ROD specific permissions.

The ROD global.asa file contains scripts run at application start and end, and session start and end. The global.asa file contains the connection string variables, error message string variables, environment variables, and variables that contain information about the current user. All of these application-level and session-level variables are initialized, however, some session-level variables are re-initialized when the user has successfully logged into the application.

There are four levels of security used for the ROD system 10. The first level or secure socket layer (SSL) provides the demonstration and production web sites the necessary security to encrypt the data as it is transmitted across the network. This requires the user to accept a site certificate prior to accessing the web site.

The second of the four levels of security is MICROSOFT WINDOWS NT® authentication. The user must go through this security layer to log-in to the site and to set and maintain their password. This validates the user's permissions on the server, controls the validation of a new password's format, and the length of time a password is valid. The web server provides this functionality via the MICROSOFT WINDOWS NT® local groups. The user's MICROSOFT WINDOWS NT® account must be added to the appropriate group by the System Administrator in order for the user to access the site.

The third level of security for the ROD system 10 is at the database level,(e.g., in the exemplary version of the SQL SERVER® database). Every ROD user is defined in the ROD_USER table and is assigned to a user group. The groups include “Application Owners,” “Data Custodians,” and “standard users”. The ROD user's group limits the options a specific user can perform in the database. Application Owners can create and modify Data Custodians and standard users, as well as perform data custodian functions, e.g., adding or updating business segments, methods, programs, purposes, services, and statuses. Data custodians can create standard users and perform data custodian functions. Application Owners, Data Custodians, and standard users can create a ROD, view RODs that the user has either the appropriate security level to access or that he or she has been individually authorized to access, add action items to RODs they have initiated, and change the status of said action items.

The fourth level of security for the ROD system 10 is provided by the ROD security level/ROD access list. Only one of these two security features is active for any given ROD. In the first security feature, the user assigns the ROD a security level (i.e., 1-5, where 1 is the lowest level and 5 is the highest level) when the ROD is created. This prevents users with a lower security level from viewing specific records. In the second security feature, a ROD access list, the ROD's initiator may create an access list for the ROD and include only those persons he or she wants to view the record. This level of security is much more specific than the “security level” type and overrides that security. As an example of how the ROD access list works, if a ROD security level is assigned at number 3, and the ROD has an access list that contains a party named John, but not a party named Jane, even if Jane's security level is 5, she will not be able to view the ROD because she is not on the access list. An access list always overrides a security level for the ROD system 10.

The ROD system architecture includes the user's workstation, a MICROSOFT WINDOWS NT® server running IIS™ version 4.0, a SQL SERVER® version 7.0 database on a server also on the network, ADO to access the database, image files, and web pages.

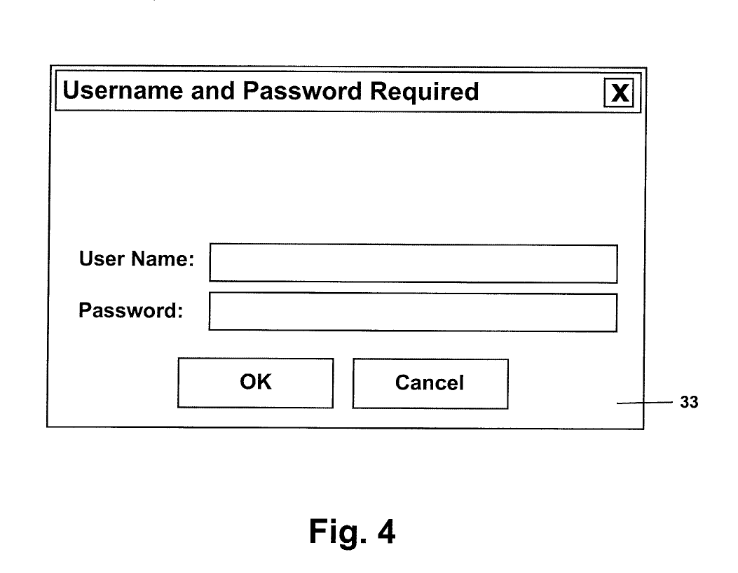

Referring to FIG. 4, a “Log-In” screen 33 shows the user name and password required for log-in to the system. The MICROSOFT WINDOWS NT® operating system on the web server provides the authentication security layer functionality. The user must go through this security layer to log-in to the site and to set and maintain their password. The user is permitted to change the user password. The authentication security layer validates the user's permissions on the server and controls the validation of a password's format and the length of time a password is valid. The format of the user name is “domain name\user name”, however, MICROSOFT WINDOWS NT® also allows a user to log-in using “domain name/user name” or just “user name” without the “domain name” if the user's name is in the default domain of the web server. The ROD_USER table stores the user names in the format “domain name\user name”. If the user successfully logs-in to the web site, but is not validated against the ROD_USER table, an error message is displayed.

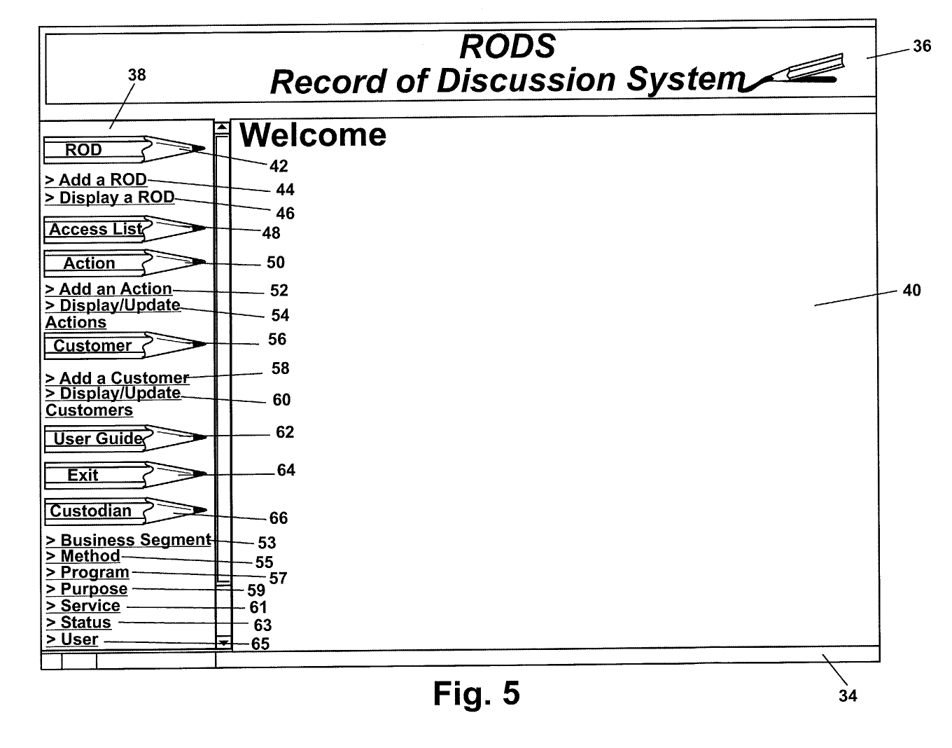

Referring to FIG. 5, a “Default” web page 34 appears to the user after successful log-in. The “Default” web page 34 comprises three main areas. In the title section 36, the ROD system 10 title is presented. In a navigation menu 38, a menu of options the user can choose from is provided. In the third section, main page 40, the input and output screens are displayed throughout the application. During the log-in process, session-level variables describing the user are initialized. The values for these variables come from the ROD_USER table and include: “SessionUserId”, which identifies the user's I.D.; “SessionUserType” which identifies the user's type, i.e. “APO” for Application Owner, “DAC” for Data Custodian, or “USR” for standard user, and “SessionUserSecLvl” which identifies the user's security level selected from a number ranging from 1 to 5.

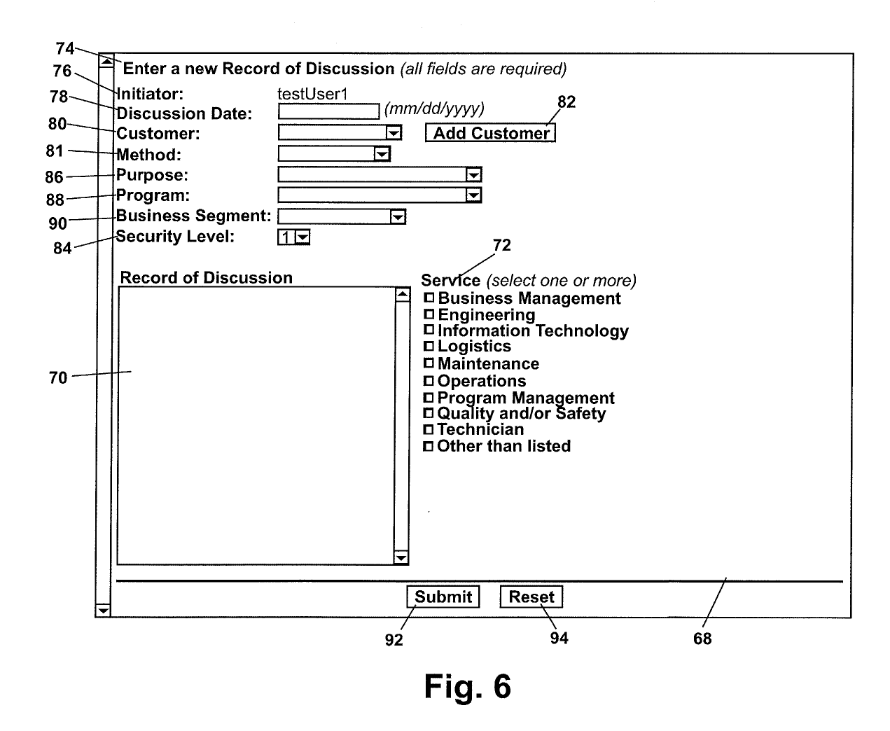

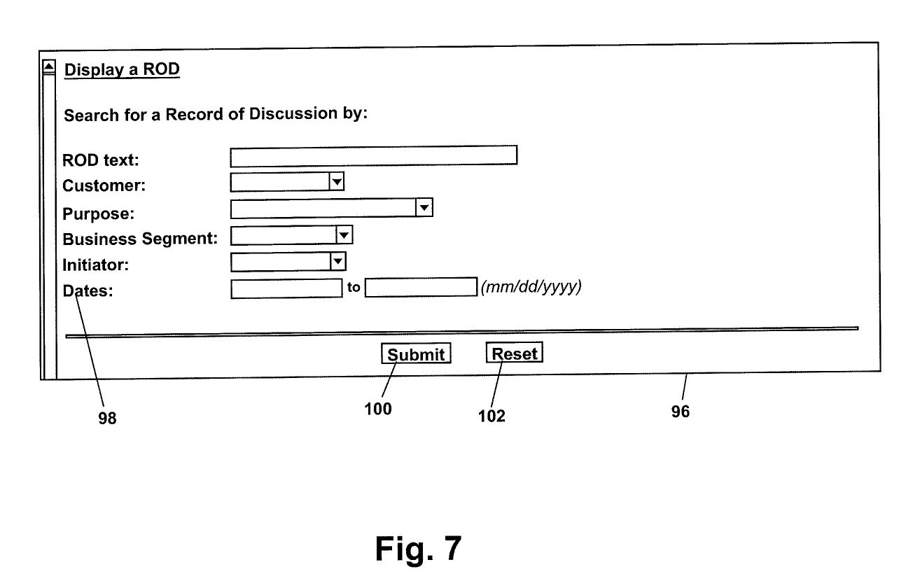

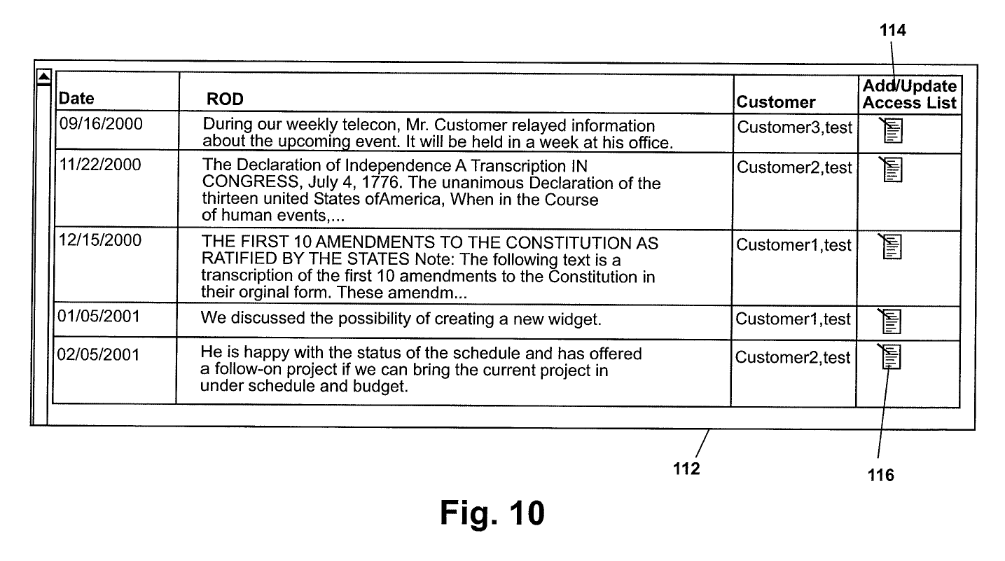

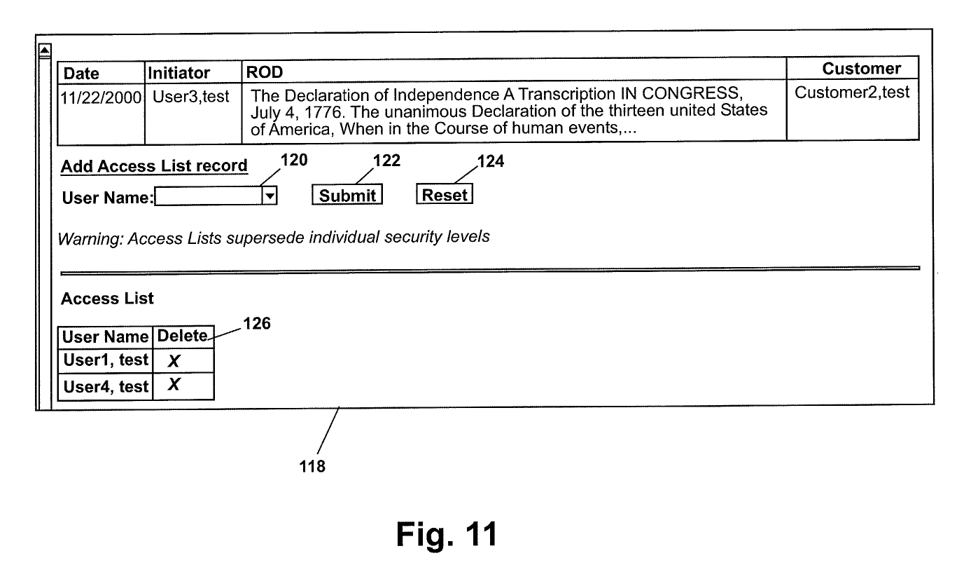

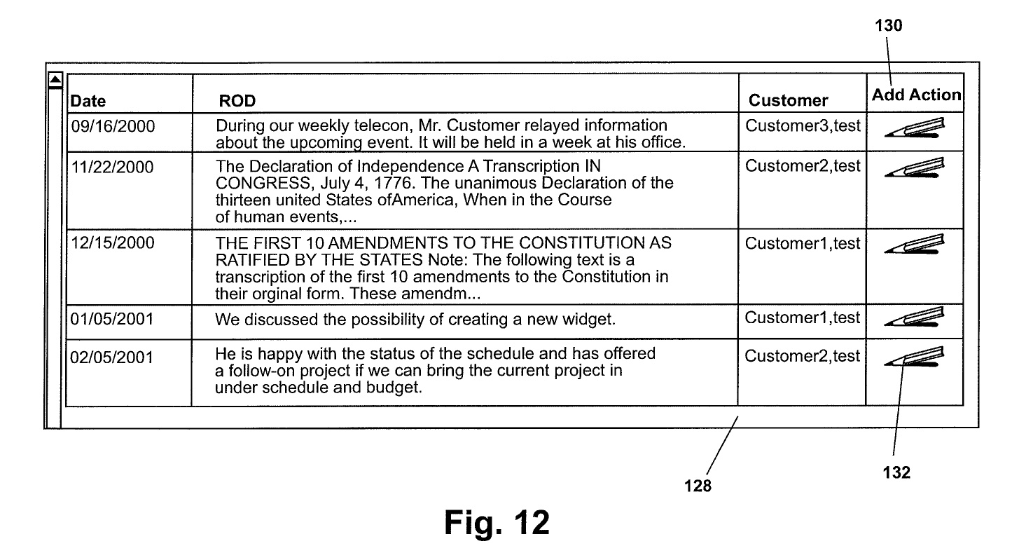

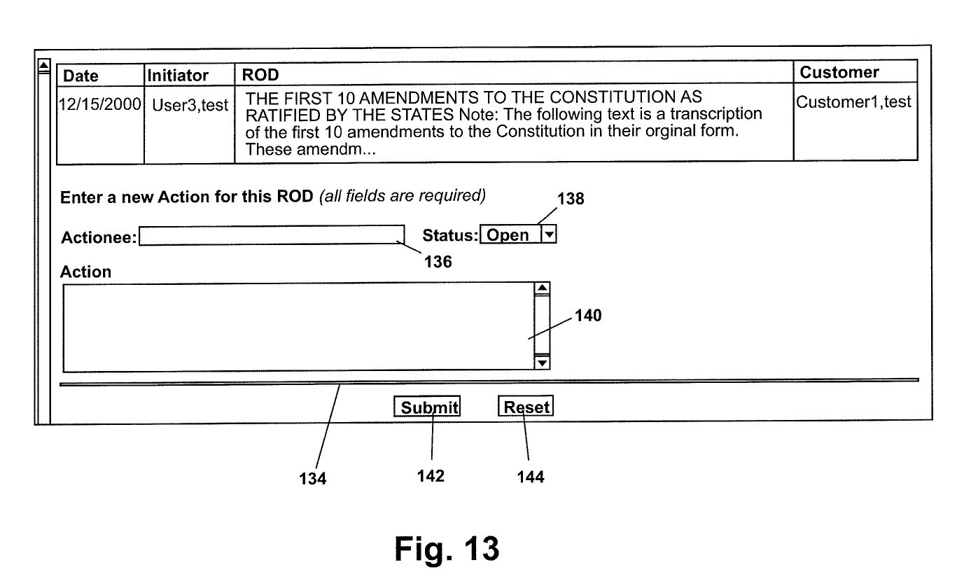

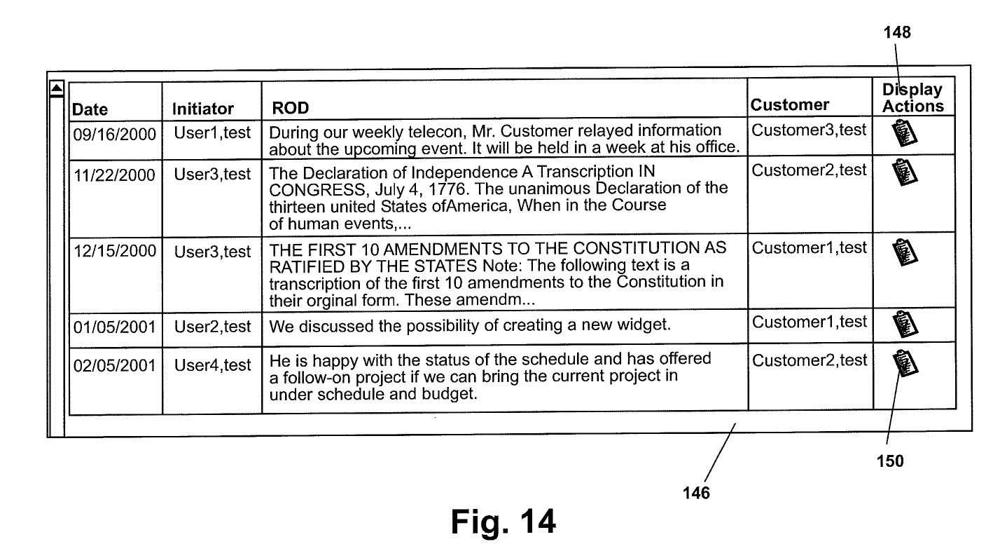

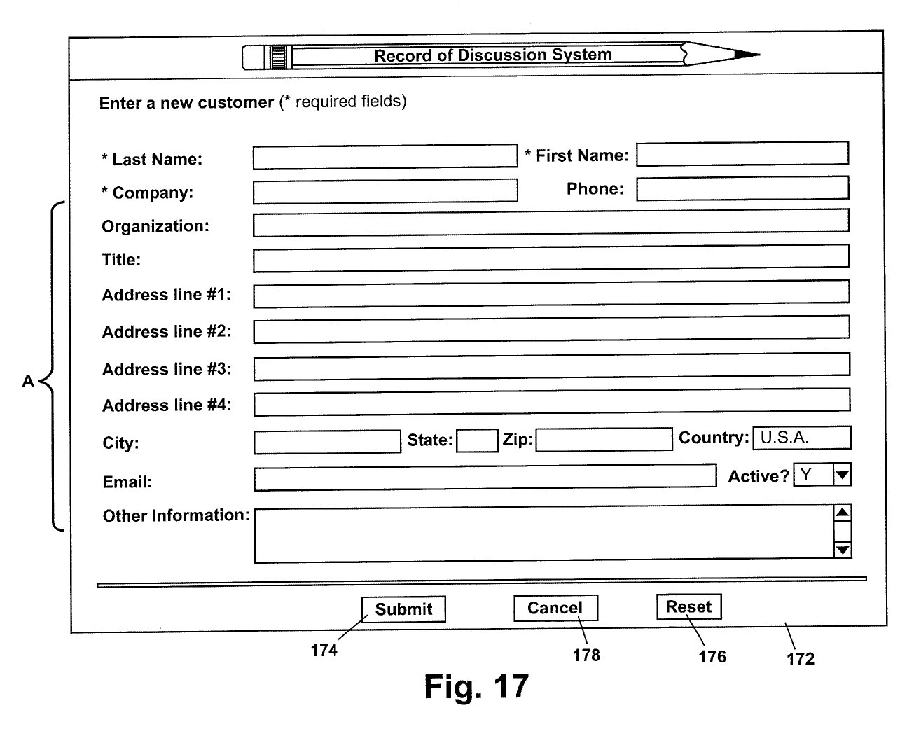

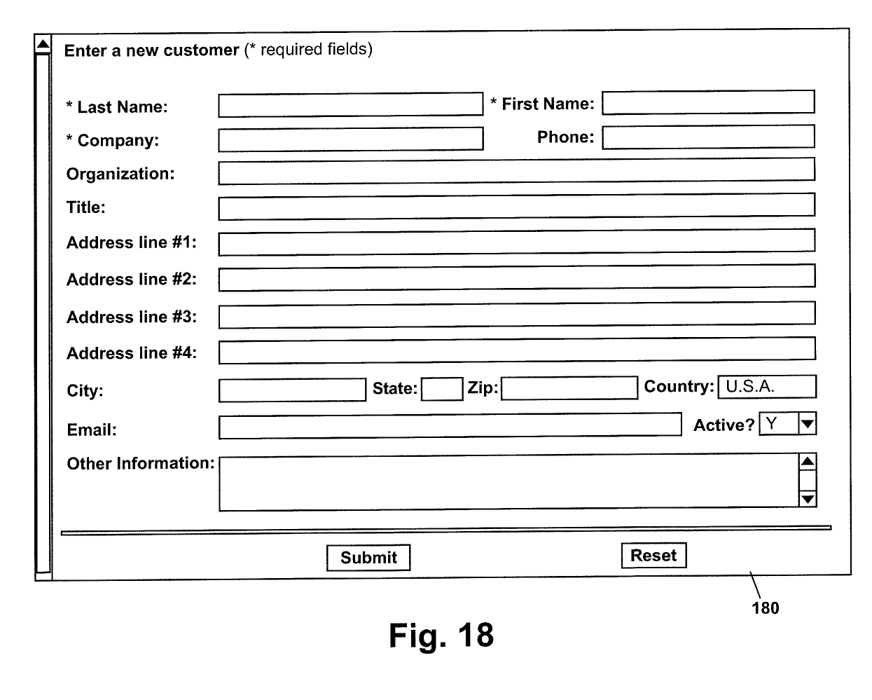

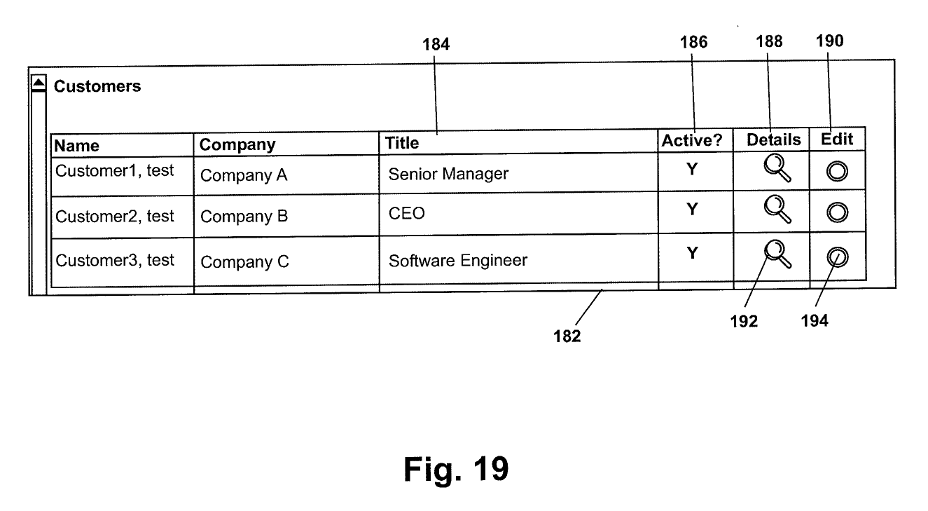

Within the navigation menu 38, displayed are several headings and buttons for the user to actuate. A ROD heading 42 provides access to individual ROD information which is further identified in FIGS. 6 through 9. The “Add a ROD” button 44 is shown and discussed in further detail with reference to FIG. 6. The “Display a ROD” button 46 is shown and discussed in further detail in FIGS. 7, 8 and 9. The “Access List” button 48 is shown and described in further detail in reference to FIGS. 10 and 11. The “Action” heading 50 is shown and discussed in further detail with reference to FIGS. 12-16. The “Add an Action” button 52 is shown and discussed in further detail with reference to FIG. 12 and FIG. 13. The “Display/Update Actions” button 54 is shown and discussed in further detail with reference to FIGS. 14-16. The “Customer” heading 56 is shown and discussed in further detail with reference to FIGS. 17-21. The “Add a Customer” button 58 is shown and discussed in further detail with reference to FIGS. 17 and 18. The “Display\Update Customers” button 60 is shown and discussed in further detail with reference to FIGS. 19 through 21. The “User Guide” button 62 is shown and when selected displays the User Guide. The “Exit” button 64 allows the user to exit the ROD application and closes the browser.

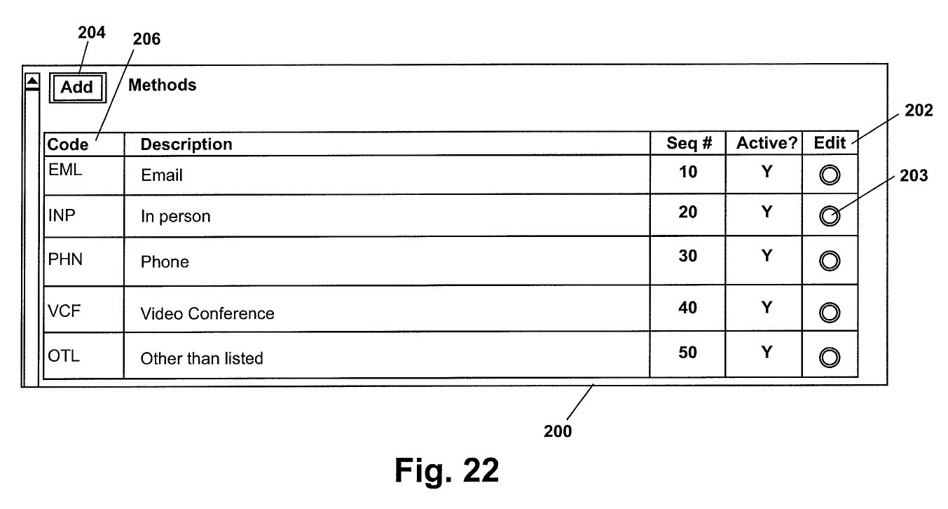

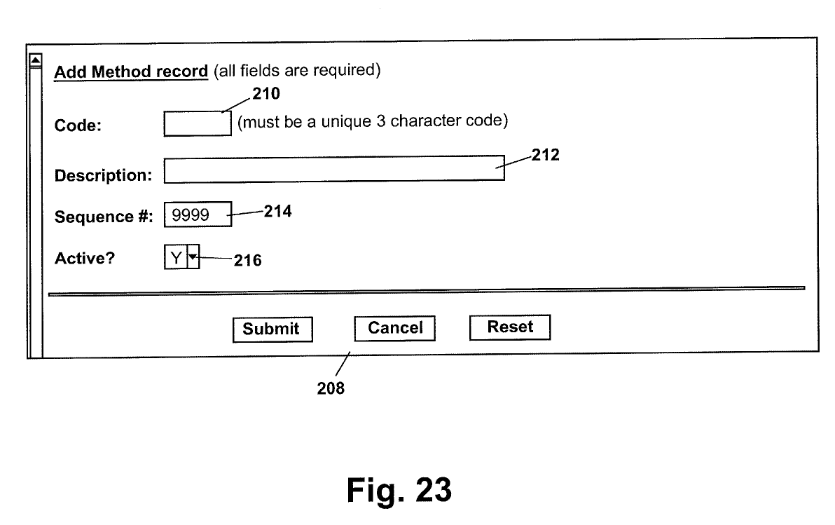

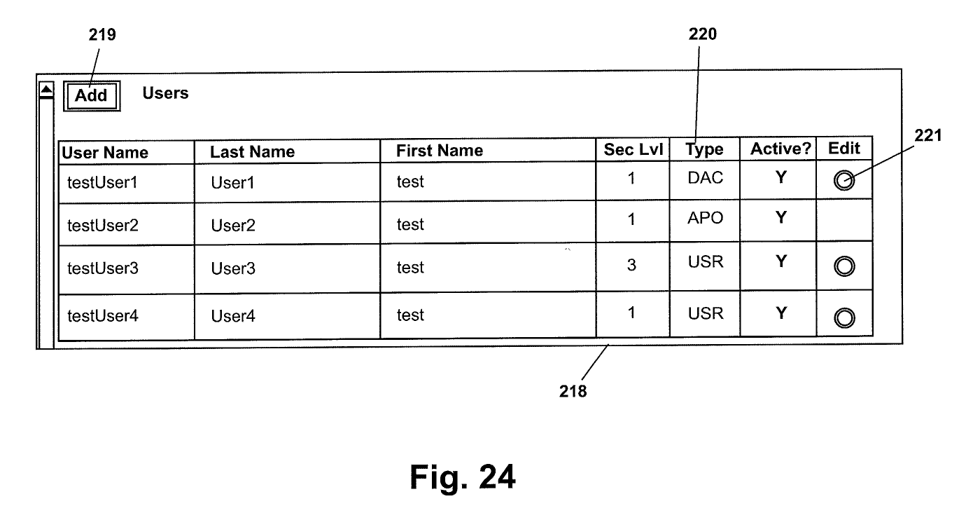

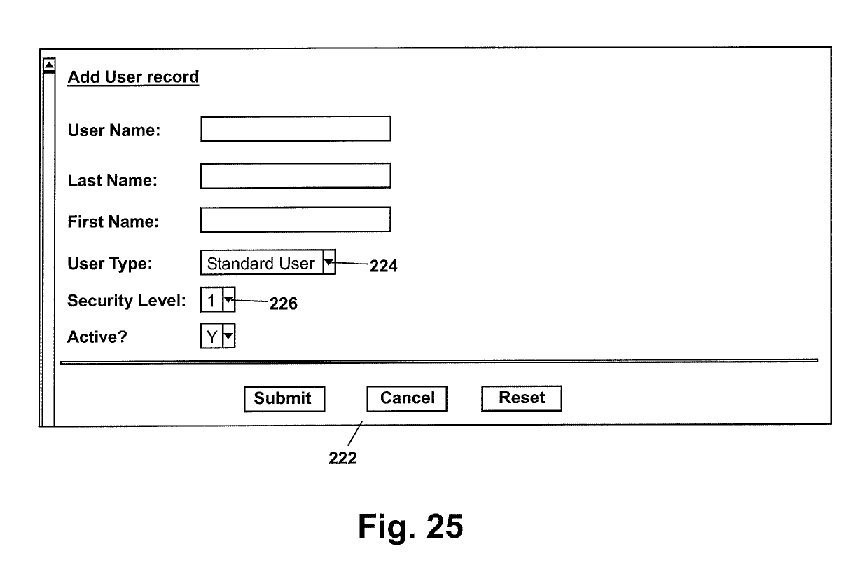

The Navigation Menu 38 provides additional selections for Data Custodians or Application Owners. A “Custodian” heading 66, is displayed only for Application Owners and Data Custodians. Standard users may not update the tables listed beneath this heading. A “Business Segment” button 53 is shown and allows modification of the data in the BUS_SEGMNT table. A “Method” button 55 is shown and discussed in further detail with reference to FIGS. 22 and 23. A “Program” button 57 is shown and allows modification of the data in the PGRM table. A “Purpose” button 59 is shown and allows modification of data in the PURPOSE table. A “Service” button 61 is shown and allows modification of data in the SRVC table. A “Status” button 63 is shown and allows modification of the data in the STATUS table. A “User” button 65 is shown and discussed in further detail with reference to FIGS. 24 and 25.

Referring now to FIG. 6, an “Add a ROD” web page 68 is shown. Note that the “Add a ROD” web page 68 has a requirement note 74 at the top of the web page. Requirement note 74 identifies that all of the fields of the “Add a ROD” web page 68 must be filled in, in order to submit the page of data. The “Initiator” field 76 identifies the initiator of the ROD. This field is populated using the current user name and is a read-only field. A “Discussion Date” field 78 identifies when the discussion occurred. Any input to this field is required to be in the format mm/dd/yyyy. An error is displayed if the user attempts to submit the record with an invalid date. The default value is the current date. A “Customer” field 80 identifies who the discussion was with. The drop-down box is populated with active records from the CUST table. If the required customer is not in the drop-down box, the user can add a new customer via an “Add Customer” button 82 but will have to reload the page to have the new customer displayed in the drop-down box. For this reason, the selection of a customer is required prior to entering the “ROD Text” field 70. If the user attempts to enter the “ROD Text” field 70 prior to selecting a customer, an error is displayed. The “Add Customer” button 82 allows the user to add a customer without having to back out of the “Add a ROD” web page 68. See FIG. 17 for additional information on the “Add a Customer” web page.

A “Method” field 81 of FIG. 6 provides the method of communication (i.e., phone, e-mail, in-person, etc.) and is populated with active records from the MTHD table. The “Purpose” field 86 identifies why the discussion took place (i.e., business opportunity, customer concern, customer request, etc.). Its drop-down box is populated with active records from the PURPOSE table. The “Program” field 88 identifies what program the discussion was about. Its drop-down box is populated with active records from the PGRM table. The “Business Segment” field 90 identifies what business segment the discussion was about. Its drop-down box is populated with active records from the BUS_SEGMNT table. The “Security Level” field 84 provides the security level assigned to the ROD. Its drop-down box is populated with numbers ranging from 1-5 (1 is the lowest security level and 5 is the highest security level). The default value is the current user's security level.

A “ROD Text” field 70 of FIG. 6 provides the ROD details. This is a text field in the database having a preferred maximum character length of (2³¹ minus 1). The wrap type on the field is virtual, therefore, format is maintained when the data in this field is saved to the database. Selection of a customer is required prior to entering the “ROD Text” field 70. If the user attempts to enter the “ROD Text” field 70 prior to selecting a customer, an error is displayed.

The “Add a ROD” web page 68 also comprises the “Service” listing 72. In the “Service” listing 72 section, one or more organizational groups within the company can be checked to identify affiliation with the ROD. The list of check boxes is dynamic. It is created at run time with active records from the SRVC table. As a result, this list may expand or collapse as new services are added and others are made inactive.

Finally, in FIG. 6, a “Submit” button 92 adds the new ROD to the database. If any required fields are missing or any data is formatted incorrectly, an error is displayed. If no errors occur, a web page stating the record was added successfully is displayed. Also, in FIG. 6, a “Reset” button 94 resets the data in the fields on the web page to the values displayed when the web page was first loaded.

Referring now to FIG. 7, a “Display a ROD” web page 96 is shown. This web page allows the user to search for an existing ROD. It is used anywhere it is necessary to select a ROD prior to performing an action. (i.e., “Display a ROD”, “Access List”, “Add an Action”, and “Display/Update Actions”). One or more search criteria fields can be selected. No particular fields are required for a search. A “free text” search can be performed by entering any known or anticipated data of a desired ROD.

The resulting list will only display the RODs the user has been previously provided with the proper security to view. A user can view a ROD if:

1. The current user is the ROD's initiator (i.e., originator);

2. The current user is not the initiator, but the current user is on the ROD's access list; or

3. The current user is not the initiator and there is no access list for the ROD, but his or her security level is greater than or equal to the ROD's security level.

FIG. 7 provides a text field for “ROD Text” and drop-down boxes for “Customer”, “Purpose”, “Business Segment” and “Initiator”, which have been previously described. In addition to these fields, the “Display a ROD” web page 96 also provides a “Dates” field 98. The “Dates” field 98 allows the user to search by discussion date. If the user enters only a \hat{ }from\hat{ } date, all RODs with discussion dates greater than or equal to that date will be displayed. If the user enters only a \hat{ }to\hat{ } date, all RODS with discussion dates less than or equal to the date will be displayed. If the user enters both a \hat{ }from\hat{ } and a \hat{ }to\hat{ } date, all RODs with discussion dates between those dates (inclusive) will be displayed. If the dates are not entered with a valid format (i.e., mm/dd/yyyy) or if the \hat{ }from\hat{ } date is greater than the \hat{ }to\hat{ } date, an error is displayed upon submit. A “Submit” button 100 queries the database using the search criteria. If any data is formatted incorrectly, an error is displayed. If no errors occur, the results of the search are displayed. A “Reset” button 102 resets the data in the fields of FIG. 7 to the values displayed when the web page was first loaded. The “Display a ROD” web page 96 is accessed by pressing the “Display a ROD” button 46 shown on the “Default” web page 34 of FIG. 5.

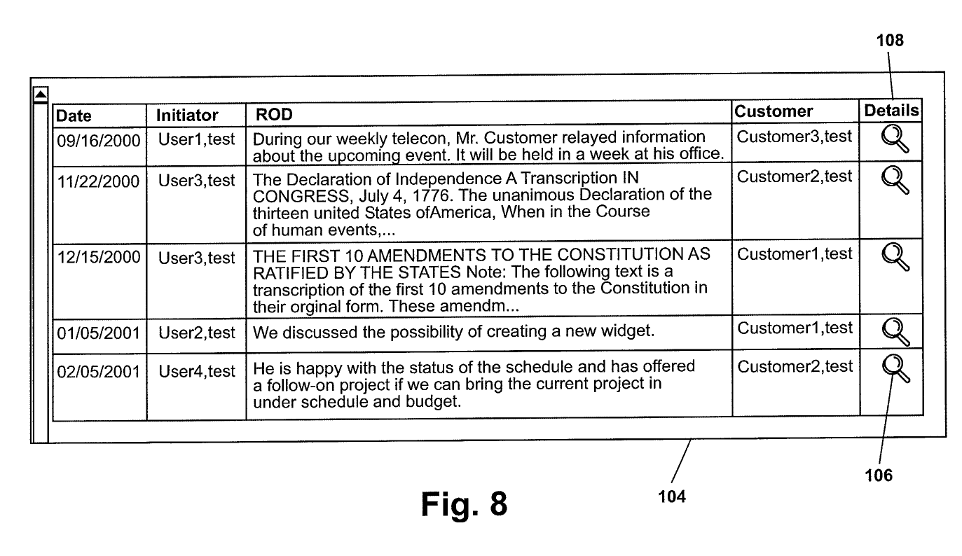

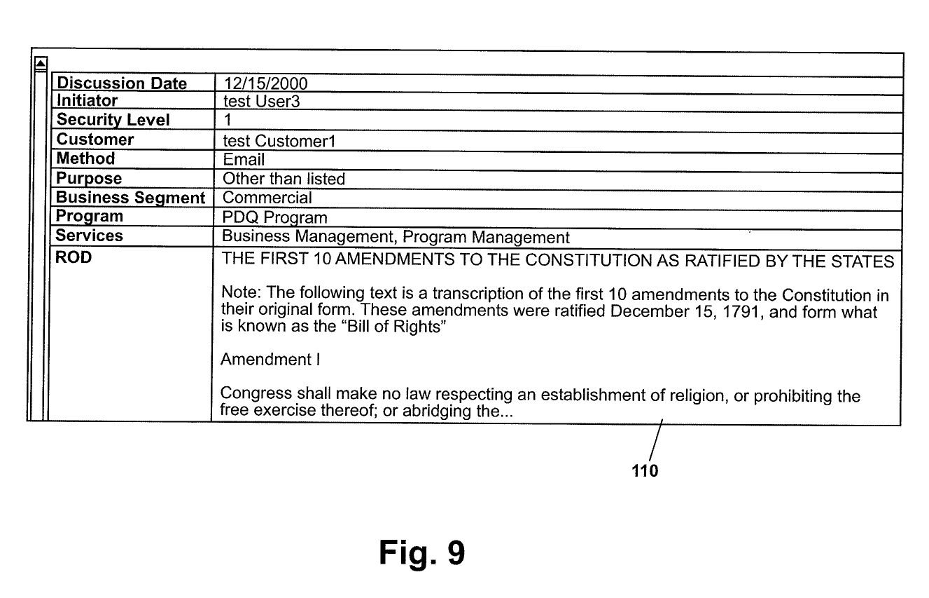

Referring to FIG. 8, a “ROD Details” web page 104 is shown. This web page displays ROD details which result from a search using the “Display a ROD” button 46 of the “Default” web page 34 of FIG. 5. By clicking on the “magnifying glass” icon button 106 in the “Details” column 108, the screen of FIG. 9 will be displayed, wherein the user can view more information on a specific ROD. As shown in FIG. 8, the Date, Initiator, ROD Text and Customer information are shown in the “ROD Details” web page 104. This data is as previously described and will not be further described herein. The list provided by the “ROD Details” web page 104 can comprise a plurality of individual RODs. As noted above, more specific information can be ascertained from any individual ROD.

Referring to FIG. 9, an “Individual ROD Details” web page 110 is shown. This web page displays the details of an individual ROD. This includes all data in the ROD_DTL and ROD_SRVC tables for a specific ROD. The information provided on this page is similar to that previously described for FIG. 8 and will therefore not be described further.

Referring to FIG. 10, an “Access List Search Results” web page 112 is shown which can be accessed after conducting a search by pressing the “Access List” button 48 of the “Default” web page 34 of FIG. 5. FIG. 10 shows the “Access List Search Results” web page 112 having Date, ROD Text, and Customer information. The “Access List Search Results” web page 112 also provides a “paper/pencil” icon button 116. This button is provided for each of the line items of data on this “Access List Search Results” web page 112. Only a ROD's initiator can add, modify, or delete access lists on a ROD. By clicking on a “paper/pencil” icon button 116 in the “Add/Update Access List” column 114, the screen of FIG. 11 will be displayed allowing the user to add a new access list, add to an existing access list, or delete from an existing access list.

Referring now to FIG. 11, a “Modify Access List” web page 118 is shown. This page provides Date, Initiator, ROD Text and Customer data. The purpose of this page is to allow the user to add, update, or delete an access list. For the user's information, a summary of the ROD is displayed at the top of the web page to remind the user which ROD he or she is working on. The “Modify Access List” web page 118 provides a “User Name” field 120, a “Submit” button 122 and a “Reset” button 124. The “User Name” field 120 provides the user name to add to the access list. The drop-down box is populated with active records from the ROD_USER table that are not already listed in the current access list. The “Submit” button 122 adds a new name to the access list. If no access list exists, adding a name will create an access list. If an access list already exists, the new name is appended to the existing list. If any required data is missing, an error is displayed. If no errors occur, the name is added and the web page is refreshed with the updated list.

The “Reset” button 124 resets the data in the fields of the “Modify Access List” web page 118 to the values displayed when the web page was first loaded. The “Modify Access List” web page 118 also provides a column of “Delete” buttons 126. By clicking on a “Delete” button 126, the name is removed from the access list. When the last name is deleted, the list is deleted. It should also be noted that the access list supercedes the individual security levels. Therefore, adding a person to an access list will supercede the security level normally applied to that person if he or she has a security level below the individual security level of the ROD. Similarly, adding a person to the “User Name” field 120 also permits that person to access the particular ROD regardless of the individual's security level. Naming a user to the “User Name” field 120 therefore may limit access to a ROD to only those persons named on the access list. Care should therefore be exercised when using the access lists.

Referring now to FIGS. 12-16, the pages that are displayed upon pressing one of the fields named under the “Action” heading 50 of the “Default” web page 34 of FIG. 5 will be discussed. After conducting a search by using the “Add an Action” button 52 option of the “Default” web page 34, an “Add Action Search Results” web page 128 is provided as shown in FIG. 12. FIG. 12 comprises columns of data including Date, ROD Text, and Customer as previously described. FIG. 12 also shows an “Add Action” column 130. Each of the RODs listed in the “Add Action Search Results” web page 128 has a “pencil” icon button 132 in the “Add Action” column 130. The initiator of the ROD can display the “Add an Action” web page 134 as shown in FIG. 13 by clicking on the “pencil” icon button 132 in the “Add Action” column 130 of FIG. 12. Only a ROD's initiator can add actions to the ROD. After clicking the “pencil” icon button 132 in the “Add Action Search Results” web page 128, an “Add an Action” web page 134 shown in FIG. 13 is provided.

Referring now to FIG. 13, the “Add an Action” web page 134 comprises data including Date, Initiator, ROD Text, and Customer for a particular ROD. A new action for the listed ROD is input in the “Add an Action” web page 134 using an “Actionee” field 136, a “Status” field 138 and an “Action” field 140. The “Actionee” field 136 identifies the person or organization responsible to complete the action. The “Status” field 138 identifies the action's status. The default value is \hat{ }open\hat{ }. The “Action” field 140 identifies the action. It is provided as a text field in the database. The wrap type on the field is virtual, therefore format is maintained when the data in this field is saved to the database. A “Submit” button 142 adds the new action for the ROD. If any required fields are missing, an error is displayed. If no errors occur, a web page stating the record was added successfully is displayed. A “Reset” button 144 resets the data in the fields on the web page to the values displayed when the web page was first loaded.

A user can list all of the actions for a ROD. A “Search Actions Results” web page 146 shown in FIG. 14 is displayed for the results of a search from the “Display/Update Actions” button 54 of the “Default” web page 34 shown on FIG. 5. The “Search Actions Results” web page 146 comprises columns of data previously described including Date, ROD Initiator, ROD Text, and Customer. This page also includes a “Display Actions” column 148. For each ROD listed in the “Search Actions Results” web page 146, a “clipboard” icon button 150 is displayed in the “Display Actions” column 148. The user can further display each ROD's actions by clicking on the “clipboard” icon button 150 in the “Display Actions” column 148. Only a ROD's initiator can modify the actions' status on the ROD, however, other users can display a ROD's actions if he or she has access to view the ROD.

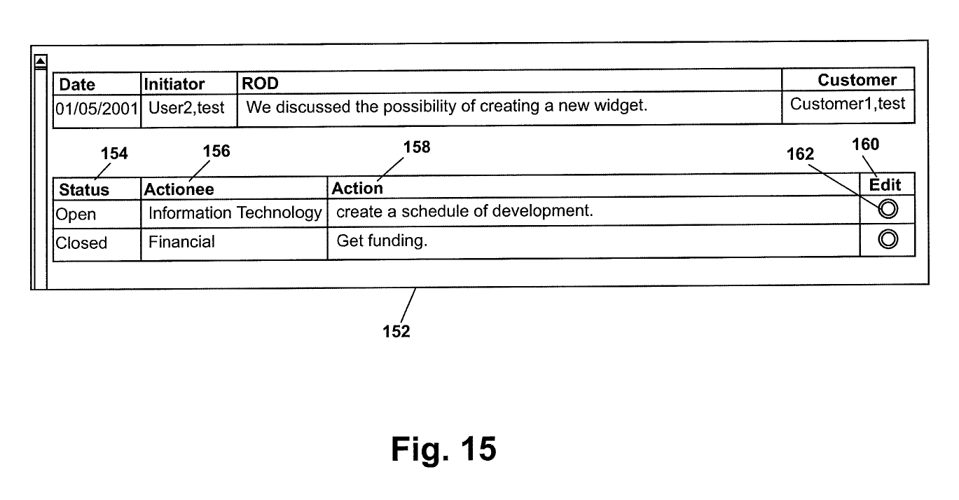

When a ROD initiator clicks on the “clipboard” icon button 150 identified in the “Display Actions” column 148 of FIG. 14, a “ROD Actions” web page 152 shown in FIG. 15 is displayed. The “ROD Actions” web page 152 comprises the action item data for a single ROD which includes information such as Date, Initiator, ROD Text, and Customer. The “ROD Actions” web page 152 also comprises a “Status” column 154, an “Actionee” column 156, an “Action” column 158, and an “Edit” column 160. All of the actions assigned to a particular ROD are displayed on the “ROD Actions” web page 152. The status of each of the ROD's actions i.e. \hat{ }open\hat{ } or \hat{ }closed\hat{ } is presented. Only if the user is also the ROD's initiator will the “Edit” column 160 be displayed. Only a ROD's initiator can modify the ROD's action status.

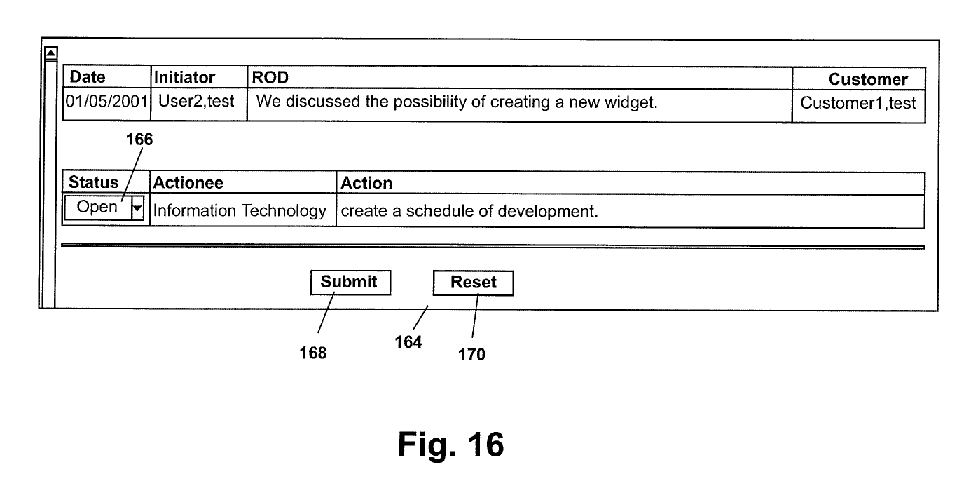

If the user is also the ROD's initiator, the user may elect to click on one of the “Edit” buttons 162 provided in the “Edit” column 160 for this purpose. Only one ROD action can be edited at a time. If an “Edit” button 162 is pressed, a “Modify an Action” web page 164 shown in FIG. 16 is displayed. The “Modify an Action” web page 164 is a simplified form of the “ROD Actions” web page 152, providing only a single ROD action. The “Modify an Action” web page 164 can only be updated in the Status column with the “Status” field 166 as shown. Clicking on the “Status” field 166 provides the user with a selection of values from the STATUS table. The “Modify an Action” web page 164 also provides a “Submit” button 168 and a “Reset” button 170. The “Submit” button 168 updates the ROD's action status in the database. If any required fields are missing, an error is displayed. If no errors occur, the database is updated and the list of actions for the ROD is refreshed and displayed. The “Reset” button 170 resets the data in the fields on the web page to the values displayed when the web page was first loaded.

Referring back to FIG. 5, options listed under the “Customer” heading 56 provide access to a user for updating, adding, or deleting information concerning a customer. Web pages displayed by selecting the options under the “Customer” heading 56 are shown and discussed in further detail with reference to FIGS. 17-21. The second way that the ROD system permits adding a customer is provided by the “Add Customer” button 82 shown on the “Add a ROD” web page 68 of FIG. 6. An initiator clicking on the “Add Customer” button 82 of the “Add a ROD” web page 68 will be shown an “Add a Customer” web page 172 of FIG. 17. The “Add a Customer” web page 172 comprises a plurality of data necessary to be entered in order to add a new customer to the CUST table.

As shown in FIG. 17, the data fields denoted with an asterisk, i.e., Last Name, Company, and First Name are required to create a new customer using the “Add a Customer” web page 172. The remaining fields denoted by the letter “A” are optional data fields. The “Add a Customer” web page 172 allows the user to create a new customer. It is also the page used to modify a customer. On submit, error messages are displayed if required fields are missing, if data is not formatted correctly, or if invalid values are entered. The data fields of the “Add a Customer” web page 172 are self explanatory and will therefore not be discussed further herein. Similar to previous web pages discussed herein, the “Submit” button 174 submits the data entered from the “Add a Customer” web page 172 to the database. A “Reset” button 176 performs a similar function as previously discussed of resetting the data in the data fields on the web page to the values displayed when the web page was first loaded. A “Cancel” button 178 is also provided in the “Add a Customer” web page 172, for the purpose of canceling the entire page prior to entry of the data into the database.

Referring to FIG. 18, a “Modified Add a Customer” web page 180 is shown. This page is displayed when adding a customer from the “Add a Customer” button 58 on the Navigation Menu 38 of FIG. 5. Both the “Modified Add a Customer” web page 180 and the “Add a Customer” web page 172 are similar pages and are displayed from the same source, therefore only the difference between the two pages will be discussed herein. Functionally, the “Cancel” button 178 provided on the “Add a Customer” web page 172 is not provided on the “Modified Add a Customer” web page 180. The only other significant difference between the two pages is the source code that the web page was generated by. Similar to FIG. 17, the asterisked items of FIG. 18 must be entered prior to an attempt to submit the record. If the user attempts to submit the record without the asterisked data, an error is displayed.

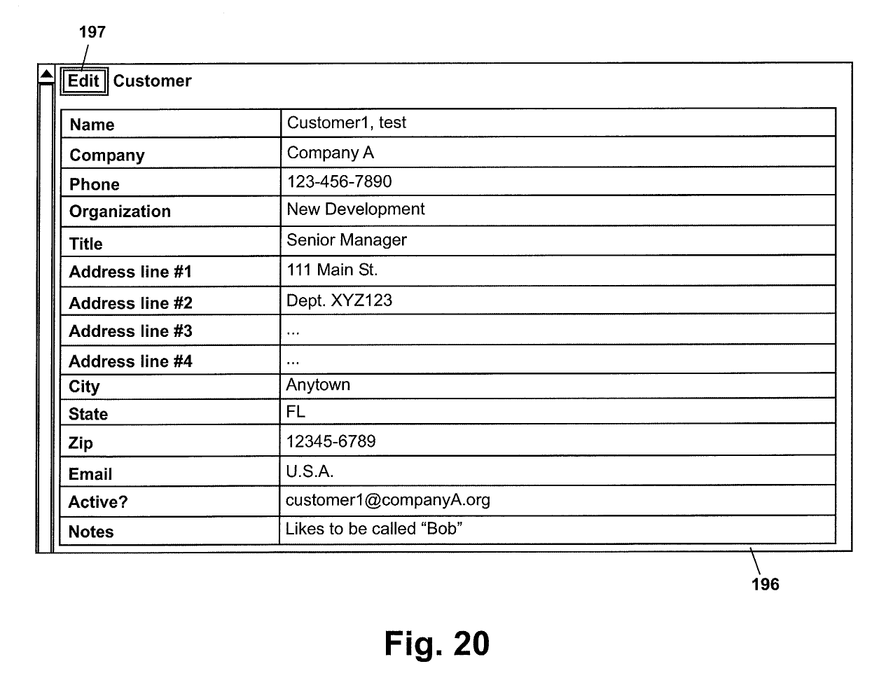

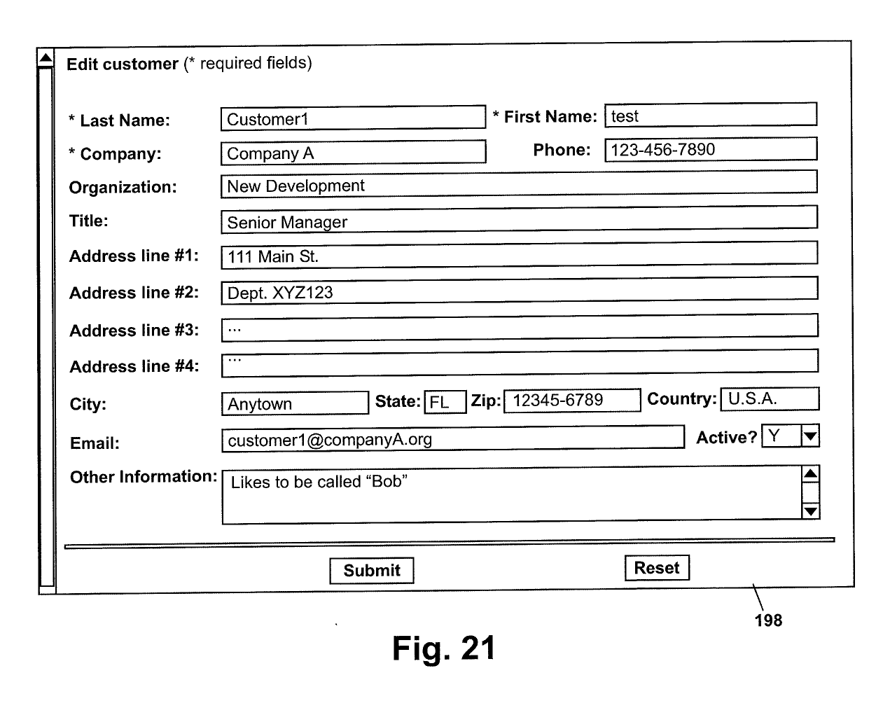

Referring to FIG. 19, a “Display Customers” web page 182 is shown. This page is comprised of data including Name and Company. In addition, the “Display Customers” web page 182 also provides a “Title” column 184, an “Active” column 186, a “Details” column 188 and an “Edit” column 190. The “Title” column 184 provides specific information on each customers' business title. The “Active” column 186 identifies either a \hat{ }y\hat{ } or \hat{ }n\hat{ } (yes or no) designation for each customer. The “Details” column 188 provides a means of selecting individual customers from the “Display Customers” web page 182 and provides more complete data for that customer. The “Edit” column 190 provides the means to edit each of the line items of the “Display Customers” web page 182. By selecting the “magnifying glass” icon button 192 of the “Details” column 188, a “Customer Details” web page 196 shown in FIG. 20 is displayed. By clicking on the “Edit” button 194 of “Edit” column 190, a “Modify a Customer” web page 198 shown in FIG. 21 is displayed.

Referring to FIG. 20, the “Customer Details” web page 196 is shown. This page displays the details of a particular customer. This includes all data in the CUST table for a specific customer. This page is viewed by clicking a “magnifying glass” icon button 192 from FIG. 19. By clicking on the “Edit” button 197, a user can modify customer data via the “Modify a Customer” web page 198 of FIG. 21.

Referring to FIG. 21, a “Modify a Customer” web page 198 is shown. This page allows the user to modify data for a customer. This is the same page format used to add a customer and will therefore not be discussed further herein.

By selecting the User Guide” button 62 shown on FIG. 5, the user is allowed to display the ROD's User Guide (not shown). Depending on the settings of the individual computer workstation, the document is either displayed in a new window or in-place in the main window.

By selecting an option under the “Custodian” heading 66 on the “Default” web page 34 of FIG. 5, an Application Owner or a Data Custodian is provided web pages which only an Application Owner or Data Custodian is permitted to access. Standard users may not access these web pages.

An Application Owner or a Data Custodian is also permitted to look up and modify data provided on individual tables including the BUS_SEGMNT, the MTHD, the PGRM, the PURPOSE, the SRVC, the STATUS, and the individual ROD_USER. Due to their similarity, most of the tables are processed using the same web pages. Only the ROD_USER table uses different web pages.

Referring to FIG. 22, a “Display Lookup” web page 200 is shown. This web page displays all records in a lookup table. All lookup tables, with the exception of the ROD_USER table, can be updated via this web page. Only an Application Owner or Data Custodian can modify data in these tables. From this web page, the user can edit a record in the “Edit” column 202 by clicking an “Edit” button 203 or add a new record by clicking the “Add” button 204. The “Display Lookup” web page 200 comprises several columns of data including “Code” column 206, “Description”, “Seq #”, “Active?”, and “Edit” column 202. The “Code” column 206 provides three-digit codes which will be described further with reference to FIG. 23. The “Edit” column 202 provides the means for an Application Owner or Data Custodian to select the individual line item of data from the “Display Lookup” web page 200 for editing. In order to edit a specific line item, an individual “Edit” button 203 is clicked. The “Add” button 204 provides the means for the Application Owner or Data Custodian to add information to the lookup table. A separate “Modify Lookup Table Data” web page (not shown), similar to FIG. 23, is displayed when selecting the “Edit” button 203.

Referring to FIG. 23 an “Add Lookup Table Data” web page 208 is shown. This web page allows users to add or modify records of a lookup table, e.g., the “Display Lookup” web page 200. The “Add Lookup Table Data” web page 208 comprises several fields. A “Code” field 210 provides a three-digit unique code for the individual record. If the user attempts to submit a record with no code, a code that is not three characters, or a code that is not unique, an error is displayed. A “Description” field 212 provides the record's description. If the user attempts to submit a record with no description, an error is displayed. The “Sequence Number” field 214 provides the record's sequence number. This number is used to sort the records when they populate a drop-down box (i.e., sorting so that “other than listed” appears last in the list). The default value is 9999. If the user attempts to submit a record with no sequence number or a non-numeric value, an error is displayed. An “Active” field 216 provides the record's active \hat{ }y\hat{ } or inactive \hat{ }n\hat{ } status. The default value is \hat{ }y\hat{ }.

By selecting the “User” button 65 shown in the “Default” web page 34 of FIG. 5, data for individual users can be viewed. Referring to FIG. 24, a “Display Users” web page 218 is shown. This web page is comprised of data including the User Name, Last Name, First Name, and Security Level. A “Type” column 220 is also provided. The “Display Users” web page 218 displays all records in the ROD_USER table. From this page, the user can add a new record by clicking the “Add” button 219 or edit a record by clicking an “Edit” button 221 similar to “Add” buttons and “Edit” buttons previously described for previous pages. Only an Application Owner or Data Custodian can modify data in this table. Application Owners are created by the System Administrator (external to the application). Application Owners can add or modify Data Custodians and standard users. Data Custodians can only add or modify standard users.

Referring to FIG. 25, an “Add Users” web page 222 is shown. This web page comprises several items of data including the User Name, Last Name, and First Name. In addition, the “Add Users” web page 222 also provides a “User Type” field 224, a “Security Level” field 226, and an “Active” field (similar to previously described web pages). This web page allows the Application Owner or Data Custodian to add users or update the data for any particular user. All fields are required. If the user attempts to submit the record with required fields missing, an error is displayed. Only Application Owners or Data Custodians can add or update users. The “User Type” field 224 provides the user's user type. The default value is “standard user”. The System Administrator is the only one who can create an Application Owner and this is accomplished outside of the ROD application (i.e., at the SQL SERVER® level). The “Security Level” field 226 provides the user's security level as previously noted (i.e., 1 is the lowest level and 5 is the highest level). The default value is 1.

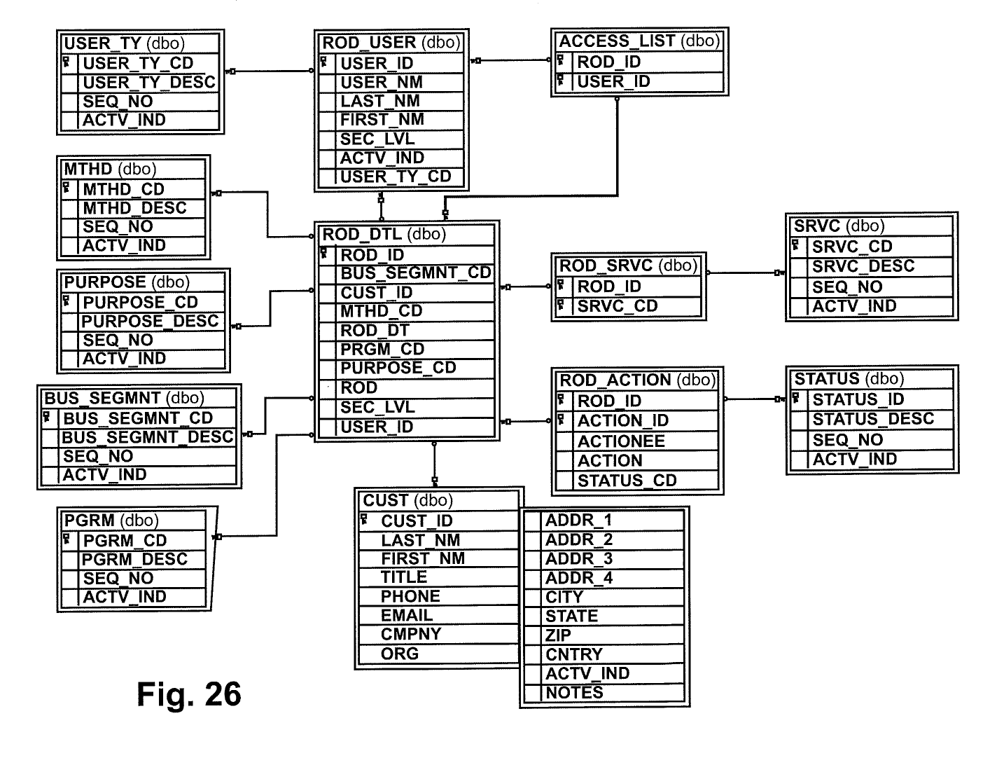

Referring to FIG. 26, an exemplary as-built design of a ROD database of the present invention is shown. Individual boxes identify each table of data headings saved within the ROD system 10. Each table is connected to the associated table(s) using the data. For example, the ROD_ACTION table contains data including the ROD Identification Number as “ROD_ID”, the ROD's action number “ACTION_ID”, the ROD's assigned actionee as “ACTIONEE”, the ROD's assigned action as “ACTION”, and the ROD's action status as “STATUS_CD”. This table of data is used in connection with generating both ROD details and ROD status, therefore the ROD_ACTION table is shown connecting to both the ROD_DTL and STATUS tables.

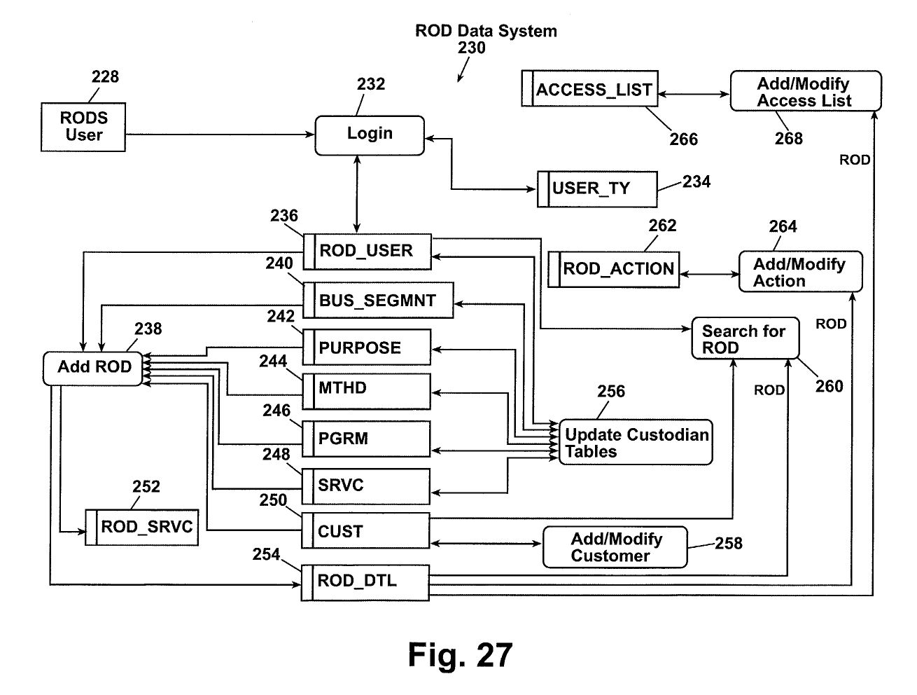

Referring to FIG. 27, a block diagram shows the data connecting paths for an exemplary ROD system 10 of the present invention. A ROD user 228 enters the ROD data system 230 via the log-in process 232. During the log-in process 232, a user type is identified from existing data in the USER_TY table 234. The user type identifies if a user is an Application Owner, a Data Custodian, or a standard user. The ROD user 228 is identified to the system via the ROD_USER table 236 and can elect to perform several functions. If the ROD user 228 wants to add a new ROD, the “Add ROD” process 238 displays the appropriate fields for data entry. Data will be retrieved from the following tables in order to populate the drop-down boxes on the “Add a ROD” web page 68 of FIG. 6: the BUS_SEGMNT table 240, the PURPOSE table 242, the MTHD table 244, the PGRM table 246, and the CUST table 250. Data will be retrieved from the SRVC table 248 in order to populate the check boxes on the “Add a ROD” web page 68 of FIG. 6.

Following new ROD data entry, service data is inserted into the ROD_SRVC table 252 and details for the new ROD are inserted into the ROD_DTL table 254. All data for tables 240 through 248 inclusive are used to update the custodian tables 256. The ROD initiator can also add or modify customer details within the CUST table 250 through the “Add/Modify Customer” process 258.

Another option available to the ROD user 228 is to conduct a search for a ROD. This option is available through the “Search for ROD” process 260. Data from the preceding tables is searched to complete a ROD search. The ROD user 228 is limited in some instances for accessing RODs based on his or her ROD user type identified in ROD_USER table 236. All RODs found during a search for which the ROD user 228 has an appropriate security level or individual access to view will be displayed.

FIG. 27 also shows that a ROD user 228, if he or she is a ROD initiator, can add or modify actions assigned to a ROD. The ROD action is stored in the ROD_ACTION table 262 and is available to a ROD initiator via the “Add/Modify Action” process 264. The “Add/Modify Action” process 264 initially searches for the action details in the ROD_ACTION table 262. A ROD user 228 identified as a ROD initiator can add ROD actions and/or modify an action's status. Similarly, a ROD user 228 identified as a ROD initiator can add to or modify a ROD's access list, which if used, overrides the security level status of a ROD. The ROD access list data is stored in the ACCESS_LIST table 266, which is accessed through the “Add/Modify Access List” process 268.

Prior to accessing the ROD system 10, a user must be set up by a System Administrator to access the website and be a user with appropriate security level to access the application. The ROD system 10 can be accessed via the World Wide Web using any standard browser. An Internet address is developed for each application of a ROD system 10. After entering the Internet address for the particular application, the user will be required to accept a site certificate, provided that during a previous ROD session the user did not already accept the certificate (i.e., until it's expiration). Instructions are provided to accept the site certificate after reading the necessary data and clicking on the appropriate button of the site certificate. The user also has the option of accepting a site certificate for only a particular session within the ROD system 10. This option will accept the certificate for that current session only. The user will be able to access the application, however, when the browser is closed, the certificate is no longer accessible and the user will be prompted to accept the certificate again the next time he or she accesses the application. If the user elects not to accept the certificate, ROD system 10 will not connect to the website and will therefore not allow the user access to the application. If the user accepts the certificate forever (i.e., until certificate expiration date), the certificate is valid for both the current session and any subsequent sessions until the expiration date of the certificate. Once the certificate expires, the user will be prompted to accept a new certificate the next time he or she accesses the application.

Selecting the “Exit” button 64 shown on the “Default” web page 34 of FIG. 5 allows the user to exit the ROD application. This option both exits the ROD application and closes the browser. In some browsers, a window confirming the action is displayed. The user must close the browser to completely exit the ROD application.

The ROD system 10 of the present invention provides several advantages. The present invention permits a “free text” entry or a cut and paste entry from other existing documents. This permits rapid input of data into the ROD system 10. A “free text” search capability based on any selected words the user identifies to search the database with is provided. A security level is assigned to each ROD and only those persons having the security level identified or a higher security level have access to the particular ROD in the system. The ROD security level can be created to any security level required. Specific areas for defined ROD information can also be searched. All RODs entered on a specific date or within a date range can be searched. The ability to add action items to each ROD ensures closed-loop tracking of customer concerns and expectations. Each ROD can have action items assigned which permits any user to identify the next action and previously completed actions.

The ROD system 10 of the present invention also provides the ability to create a user defined access list for each ROD item in lieu of the security levels. This is a specific list of named users who can subsequently access the ROD data and provides a more specific method of controlling access to data in the ROD system 10 than the general security level previously identified.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for recording, securing and retrieving for use record of discussion items, said method comprising the steps of:
providing a computer system including a database and interface architecture;
capturing a plurality of record of discussions (RODs) for entry in the system database;
entering each ROD via a plurality of web pages of the interface architecture in the database; and
interconnecting the system via a scalable Internet-based environment to at least one user site.

2. The method of claim 1, further comprising the steps of:
restricting database access to a user group including at least one ROD application owner and a plurality of users; and
enabling security access to the system for at least one of said plurality of users as a ROD initiator to initialize and enter each ROD in the database.

3. The method of claim 2, further comprising the steps of:
providing ROD access to the user group in a plurality of searchable fields displayed on predetermined ones of said web pages;
disposing each of the plurality of searchable fields in one of a set of drop-down lists of values on said web pages; and
using the set of drop-down lists of values to one of input, search and update said ROD items.

4. The method of claim 3, further comprising the step of accessing said system through a web browser.

5. The method of claim 3, further comprising the steps of:
defining a set of security level codes selected from a range of values inclusive between 1 being a lowest security level and 5 being a highest security level;
assigning each user of the user group one of the set of security level codes;
entering one of the security level codes in each ROD by the ROD initiator to establish a ROD security level; and
limiting access to each ROD to a portion of the user group assigned one of equal to and greater than the ROD security level.

6. The method of claim 5, further comprising the steps of:
creating a list of individual user names from the user group;
entering at least one name of the individual user names on at least one ROD; and
overriding the ROD security level code with the at least one name of the individual user names to establish a ROD security access list.

7. The method of claim 6, further comprising the step of controlling a quantum of RODs accessible to each user by one of the security level code and the at least one user name.

8. The method of claim 2, further comprising the step of locking an original version of each ROD after ROD entry.

9. The method of claim 8, further comprising the step of selecting the application owner from the plurality of users, said application owner authorized to establish a security level for each of the plurality of users.

10. The method of claim 2, further comprising the step of selecting at least one data custodian from the plurality of users, said at least one data custodian authorized to establish a security level for each of the plurality of users.

11. A data recording, securing and retrieving system for using record of discussion items, said data system comprising:
a plurality of record of discussions (RODs) each having individual data blocks to distinguish each ROD, and each capable of being electronically stored;
a database to electronically store the plurality of RODs;
a plurality of web pages each having a plurality of data fields to input each data block of each ROD into said database;
each ROD further including a security designator to secure each ROD, said designator attached to each ROD via at least one of the plurality of data fields of the plurality of web pages; and
said database being interconnected via a scalable Internet-based environment with a plurality of users.

12. The data system of claim 11, wherein each of said web pages is displayable on a computer monitor.

13. The data system of claim 12, further comprising:
a selected group of said web pages including a plurality of searchable fields disposed therein; and
each of said plurality of searchable fields usable to one of input and search the data blocks of each ROD.

14. The data system of claim 12, further comprising:
said data fields being in communication with select ones of a plurality of data tables for storing each data block; and
each data table is displayable on said computer monitor.

15. The data system of claim 11, further comprising:
a default web page having a plurality of selectable button icons to access select web pages of the plurality of web pages;
said default web page having a plurality of custodian button icons disposed thereon; and
said plurality of custodian button icons selectable to access predetermined web pages from the plurality of web pages by one of an application owner and at least one data custodian.

16. The data system of claim 15, wherein each of said plurality of users is selected from the group comprising: said application owner, said at least one data custodian and a plurality of standard users.

17. The data system of claim 16, further comprising:
said plurality of web pages being divisible into a first group and a second group;
said first group of web pages having a first security level limiting ROD access to the application owner and said at least one data custodian; and
said second group of web pages having a second security level allowing access to said plurality of standard users.

18. The data system of claim 14, wherein said plurality of data tables further comprise at least one of a user type table, a method table, a purpose table, a business segment table, a program table, a ROD user table, a ROD detail table, a customer table, an access list table, a ROD service table, a ROD action table, a service table, and a status table.

19. A system architecture comprising:
a plurality of record of discussions (RODs);
said plurality of RODs electronically stored in a database;
each ROD being transferable to said database by a plurality of web pages;
said plurality of web pages being displayable on a computer display monitor of a computer workstation;
each web page displayable on said computer display monitor being linked to a security system to control access to individual RODs in the database;
said database controlled by said security system in communication with a web server; and
said web server being interconnected to an Internet-based environment remotely linking said database with a plurality of users.

20. The system architecture of claim 19, further comprising:
said plurality of web pages having a plurality of data fields; said plurality of data fields searchable in a free text search mode; and
said free text search mode linking a search term of one of the plurality of data fields with the database.

21. The system architecture of claim 20, further comprising:
said free text search mode in communication with said database to produce a search report; and
said search report including a list of RODs.

22. The system architecture of claim 21, further comprising:
a group of security levels ranging in value between 1 and 5;
each of said plurality of users having an assigned security level selected from one of the group of security levels; and
each ROD of said plurality of RODs having a ROD security level.

23. The system architecture of claim 22, further comprising:
said ROD security level selected from one of said group of security levels; and
wherein said list of RODs provided by said free text search mode is limited to RODs having the ROD security level one of equal to and lesser than the assigned security level of a selected one of said plurality of users.

24. The system architecture of claim 22, further comprising:
each of said plurality of users having a user name; and
each user name forming an individual security clearance within said security system.

25. The system architecture of claim 24, further comprising:
each ROD having both said ROD security level selected from one of said group of security levels and at least one individual security clearance; and
wherein said individual security clearance overrides said ROD security level and each ROD of said list of RODs provided by said free text search mode is limited to the individual security clearance of the selected one of said plurality of users.
